(19) United States
(12) Patent Application Publication
(10) Pub. No.: US 2015/0254830 A1
(43) Pub. Date: Sep. 10, 2015

(54) Shape Inspecting Device And Shape Inspecting Method

(71) Applicant: KEYENCE CORPORATION, Osaka (JP)

(72) Inventors: Masato Shimodaira, Osaka (JP); Hidekazu Katsuyama, Osaka (JP)

(73) Assignee: KEYENCE CORPORATION, Osaka (JP)

(21) Appl. No.: 14/601,261

(22) Filed: Jan. 21, 2015

(30) Foreign Application Priority Data
Mar. 5, 2014 (JP) 2014-043019

(51) Int. Cl. G06T 7/00; G06K 9/46

(52) U.S. Cl. CPC G06T 7/0004; G06K 9/4604; G06T 2207/30164

(57) ABSTRACT

Information concerning a height of a shape of a workpiece is acquired accurately at high speed. A plurality of segments arrayed in one direction are set on a distance image including height information in a surface shape of a workpiece (S1). A type of a representative value concerning height information in each pixel included in each segment is selected, and this selected representative value is obtained for each segment (S2). An abnormality in a specific representative value is detected from an acquired trend, and is outputted (S4).

### CROSS-REFERENCE TO RELATED APPLICATIONS

The present application claims foreign priority based on Japanese Patent Application No. 2014-043019, filed Mar. 5, 2014, the contents of which is incorporated herein by reference.

### BACKGROUND OF THE INVENTION

1. Field of the Invention

The present invention relates to a shape inspecting device and a shape inspecting method which can acquire information concerning a height of an inspection target. The present invention is typically applied to inspection of presence or absence of a defect concerning a height of an inspection target.

2. Description of Related Art

Image processing is frequently used for inspecting a product, namely, inspecting presence or absence of a defect of a product. In the image processing of this kind, high-speed and accurate inspection processing is required for inspecting a large amount of products in a flow operation.

JP 2004-145505 A discloses an image processing device that measures an edge width of an inspection target (hereinafter referred to as “workpiece”) and makes a defect determination on the workpiece by use of a result of the measurement. In the image processing device of JP 2004-145505 A, a window is set on an image displayed on a display part, and a plurality of window elements (segments) are arranged in this window at predetermined pitches. Then, an edge width of the workpiece is measured in each window element (segment), to obtain a maximum edge width in each window element (segment). As a result, when there is a nonstandard maximum edge width, an NG (“defective”) determination is made.

JP 2009-186338 A discloses an image processing device for detecting a position and a size of a defect in a contour line of a workpiece by use of window elements (segments) as in JP 2004-145505 A. This image processing device obtains an approximate curve based on an edge point row showing the contour line of the workpiece. A method for obtaining this approximate curve is calculating a plurality of representative edge points and interpolating the representative edge point row, to obtain a pseudo approximate curve (free curve). With this pseudo approximate curve taken as a reference, the presence or absence of a defect and a size of the defect can be detected based on a difference from this approximate curve.

In recent years, manufacturing support by a computer has been established, and manufacturing based on three-dimensional CAD data has been broadly performed. JP 2001-82951 A discloses an alignment device that aligns CAD data with noncontact measuring point data, obtained by measuring an object manufactured based on this CAD data by a three-dimensional scanner, a tomographic image capturing device or the like, to inspect whether the object has been manufactured in accordance with the CAD data.

By using the alignment device of JP 2001-82951 A, it is possible to measure a height of a workpiece and inspect a defect of the height. However, naturally, the existence of CAD data is essential for this alignment device. In addition, processing of accurately aligning CAD data with noncontact measuring point data is processing with a high load. Accordingly, in the case of having to make an NG determination at a high speed as in inspection of a shape defect of a workpiece that is carried on a belt conveyor, the above alignment device based on CAD data is not suitable.

### SUMMARY OF THE INVENTION

An object of the present invention is to provide a shape inspecting device and a shape inspecting method which can acquire information concerning a height of a shape of a workpiece accurately at high speed.

A further object of the present invention is to provide a shape inspecting device and a shape inspecting method which can specify a local difference concerning a height of a shape of a workpiece accurately at high speed.

Another object of the present invention is to provide a shape inspecting device and a shape inspecting method which can specify a place with a locally different height from an image of a workpiece displayed on a display part, and can make the specification at high speed.

A further object of the present invention is to provide a shape inspecting device and a shape inspecting method which can inspect a defect concerning a height of a surface shape of a workpiece accurately at high speed.

At the time of three-dimensionally displaying a workpiece on a display part, information concerning a height is included in each pixel of the display part. That is, an image displayed on the display part is three-dimensionally displayed by color coding or luminance based on height information included in each pixel. The present inventors focused on this height information included in the pixel, to achieve the present invention.

According to one embodiment of the present invention, the above technical object is achieved by providing a shape inspecting device including: a distance image acquiring unit for acquiring a distance image that includes height information in a surface shape of a workpiece; a display unit for displaying the acquired distance image; a segment setting unit for setting a plurality of segments, arrayed in one direction, on the distance image displayed on the display unit; and a representative value selecting unit for selecting a type of a representative value concerning height information in each pixel included in each segment of the plurality of segments, wherein the representative value selected by the representative value selecting unit is obtained for each segment.

According to another embodiment of the present invention, the above technical object is achieved by providing a shape inspecting method including: a distance image acquiring step of acquiring a distance image that includes height information in a surface shape of an inspection target; a display step of displaying the acquired distance image on a display part; a segment setting step of setting a plurality of segments, arrayed in one direction, on the distance image displayed on the display part; and a representative value selecting step of selecting a type of a representative value concerning height information in each pixel included in each segment of the plurality of segments, the method including a representative value extracting step of obtaining the representative value, selected by the representative value selecting step, for each segment.

According to the present invention, when the one direction is referred to as a “trend direction”, by obtaining a representative value in each segment of the plurality of segments arrayed in the one direction, it is possible to promptly acquire a tendency (trend) of the surface shape of the inspection target (workpiece) (trend measurement). Then, when a specific representative value is different from the trend of the surface shape of the workpiece, it is possible to determine that this representative value is different from the trend, and when it is different from the trend by an amount not smaller than a predetermined value, it is possible to determine that the surface shape of the workpiece is defective. Further, based on a difference in numeric value between the trend and the representative value of each segment, it is possible to obtain a volume and a size (deviation of a height) of a predetermined region, for example. In this case, it is preferred to set a line that serves as a reference in the trend direction of the workpiece surface, namely, a reference model line, which will be described later. A user may be able to previously set a window in order to define a partial measurement area of the workpiece surface.

As for the representative value, a representative value compatible with the user's purpose may be selected depending on the user's purpose. An arbitrary value can be selected as long as the surface shape of the workpiece can be grasped. Typical examples of the representative value include an average value, a maximum value and a minimum value. In order to obtain a maximum value (or minimum value) which is effective when local unevenness of the workpiece surface is to be detected, in a plurality of pixels included in each segment, projection processing, namely, averaging processing, may be performed on height information of a pixel group in a direction along the one direction, to acquire one-dimensional data of the height information, and this one-dimensional data may be scanned in a direction vertical to the one direction, to acquire the maximum value (or minimum value). Hence, it is possible to acquire a stable maximum value (minimum value) not susceptible to significant noise in each segment.

A reference line may be obtained for grasping the trend. This reference line can be estimated from representative values of a plurality of segments. Examples of the reference line include a straight line, a circle and a free curve. By obtaining a reference line, it is possible to compare this reference line with each representative value, so as to determine a defect of the surface shape of the workpiece. That is, it is possible to inspect a defect concerning the height of the surface shape of the workpiece accurately at high speed. Further, it is possible to express a difference between the reference line and each representative value in a numerical form based on the reference line.

In order to automatically arrange the segment, a window for defining a measurement area may be set on a distance image displayed on the display unit. This window may be manually set by the user. It is easy to arrange a plurality of segments at predetermined pitches on a measurement area defined by the window, and this can be automatically performed. The user may designate a width of the segment and a pitch between the segments.

Other objects of the present invention and effects of the present invention will become apparent from descriptions of an embodiment which will be described later.

### BRIEF DESCRIPTION OF THE DRAWINGS

FIG. 1 is a configuration diagram of a shape inspecting device of an embodiment;

FIG. 2 is a diagram for explaining an example of setting a window, which extends in a horizontal direction, on a captured image displayed on a display part, to allocate a plurality of segments in this window;

FIG. 3 is a diagram for explaining an example of setting a window, which extends diagonally, on a captured image displayed on the display part, to allocate a plurality of segments in this window;

FIG. 4 is a diagram for explaining an example of setting a circular ring-shaped window on a captured image displayed on the display part, to allocate a plurality of segments in this window;

FIG. 5 is a diagram for explaining an example of setting a C-shaped window, formed by cutting off part of a circular ring, on a captured image displayed on the display part, to allocate a plurality of segments in this window;

FIG. 6 is a diagram for conceptually explaining a method for obtaining a maximum height (representative value) by averaging processing;

FIG. 7 is a diagram for conceptually explaining a method for acquiring a minimum height by averaging processing;

FIG. 8 is a flowchart for explaining a processing procedure for a first mode to make a defect determination based on whether or not a representative value of each segment is within a common tolerance range;

FIG. 9 show diagrams for explaining a specific example of the defect determination in the first mode, and for explaining an example where an electronic component to be inspected is provided with a plurality of terminals and a height abnormality in a terminal on a relatively low height level is detected, to make an NG determination.

FIG. 10 is a diagram showing a semicircular workpiece whose radius is obtained by use of a function of the first mode;

FIG. 11 is a captured image of the workpiece of FIG. 10;

FIG. 12 is a diagram showing a state where segments are set on the captured image of FIG. 11;

FIG. 13 show graphs each plotted with an “average height” (representative value) of each segment illustrated in FIG. 12;

FIG. 14 is a diagram showing a bottom of a can where an volume of a recess is to be obtained by use of the first mode;

FIG. 15 is a captured image (height image) of the bottom of the can of FIG. 14;

FIG. 16 is a diagram showing a welded region;

FIG. 17 is a captured image (height image) of the welded region of FIG. 16;

FIG. 18 is a diagram showing a state where segments are set on the captured image of the welded region of FIG. 17;

FIG. 19 is a graph plotted with a “maximum height” (representative value) of each segment on the captured image of FIG. 18;

FIG. 20 is a diagram for explaining that part of the maximum heights deviates from a tolerance by writing the tolerance to the graph of FIG. 19;

FIG. 21 is a flowchart for explaining a processing procedure for a second mode;

FIG. 22 show diagrams for explaining an example of detecting, by use of the second mode, that one terminal of the electronic component of FIG. 9 is on a relatively low height level based on data of a difference from the reference model line;

FIG. 23 show diagrams for explaining an example of detecting a defect of the workpiece with an arc-shaped section of FIG. 10 by use of the second mode;

FIG. 24 show diagrams for explaining an example of detecting a defect of the bottom of the can of FIG. 15 by use of the second mode;

FIG. 25 show diagrams for explaining an example of detecting a defect of the welded region of FIG. 19 by use of the second mode;

FIG. 26 is a height image of the welded region of FIG. 16 at the time when a height reference is not designated by the user and a reference plane of an imaging system is taken as a zero plane;

FIG. 27 is a height image of the welded region of FIG. 16 at the time of the user designates a “plane reference”;

FIG. 28 is an image showing a measurement result of the welded region of FIG. 16 at the time when the “plane reference” is designated;

FIG. 29 is a height image at the time of setting a second measurement area in each segment of the welded region of FIG. 16;

FIG. 30 is a height image at the time of setting the second measurement area in each segment 30 of the welded region of FIG. 16, as in FIG. 29;

FIG. 31 is a diagram for explaining an example of measuring a trend of an inflection point; and

FIG. 32 show diagrams for illustratively explaining one method in the case of measuring a desired inflection point.

### DETAILED DESCRIPTION OF PREFERRED EMBODIMENT

### Embodiment

Hereinafter, a preferred embodiment of the present invention will be described based on the drawings. However, the embodiment that will be described below illustrates a shape inspecting device and a shape inspecting method for embodying a technical idea of the present invention. Here, in the present specification, a term “distance image” or “height image” is used to indicate an image including height information.

Configuration of Shape Inspecting Device:

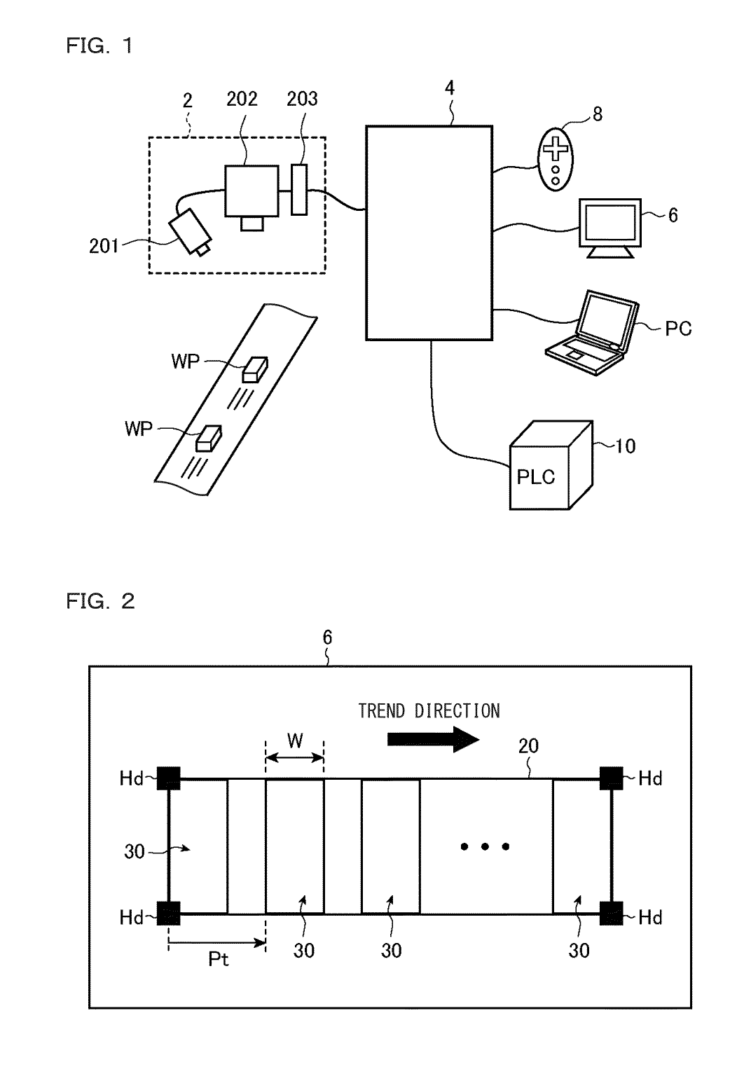

FIG. 1 shows a configuration of a shape inspecting device 1 of the embodiment. This shape inspecting device 1 has a head part 2 and a controller part 4. The head part 2 is provided with a light projecting unit 201 for illuminating an inspection target (workpiece) WP, an imaging unit 202 for capturing a multi-level image of the workpiece WP, and a head-side communication unit 203 for connecting the head part 2 to the controller part 4.

The controller part 4 determines a defect of a surface shape of the workpiece WP whose image has been captured. That is, based on height information included in each pixel, the controller part 4 detects a difference in local height from its periphery, and displays, on a display part (typically, liquid crystal monitor) 6, a workpiece surface image that can be decided by the detection, while executing processing such as edge detection and area calculation of the captured image (workpiece) and defect detection of the surface shape. Further, the controller part 4 can be detachably connected with an input unit 8 such as a console for the user performing a variety of operations on the display part 6, a PLC (Programmable Logic Controller) 10, and the like.

The shape inspecting device 1 acquires a multi-level image from the head part 2. An image including height information may be generated by a phase shifting method or a space coding method, which requires the workpiece WP to be in a still state, or an image including height information may be generated by a light sectioning method which assumes the moving workpiece WP.

The imaging unit 202 captures an image of the workpiece based on a control signal inputted from a PLC 10, e.g., an imaging trigger signal that defines timing for fetching image data from the imaging unit 202, and this imaging data is supplied to the controller part 4.

The controller part 4 can also be connected with a personal computer PC for generating a control program of the controller part 4. Further, a three-dimensional image processing program for making a setting concerning three-dimensional image processing can be installed into the personal computer PC, to make a variety of settings for processing that is performed in the controller part 4. Alternatively, a processing sequence program for defining a processing sequence of image processing can be generated by software operated on this personal computer PC.

In the controller part 4, each image processing is sequentially executed along the processing sequence. The personal computer PC and the controller part 4 are connected via a communication network, and the processing sequence program generated on the personal computer PC is transmitted to the controller part 4 along with layout information for defining a display aspect of the display part 6, or the like, for example. Further, on the contrary, the processing sequence program, the layout information or the like can be fetched from the controller part 4 and edited on the personal computer PC. In addition, it may be made possible to generate this processing sequence program not only in the personal computer PC but also in the controller part 4.

The shape inspecting device 1 makes a necessary setting such as image processing by the image processing program, and thereafter performs necessary processing, inspection and determination based on a multi-level image acquired from the head part 2.

A “distance image (height image)” obtained by using the imaging unit 202 and the light projecting unit 201 shown in FIG. 1 refers to an image in which a gray value of each pixel changes in accordance with a distance to the workpiece WP from the imaging unit 202 for capturing an image of the workpiece WP. In other words, it may be an image whose gray value is decided based on the distance from the imaging unit 202 to the workpiece WP, or it may also be a multi-level image having a gray value in accordance with the distance to the workpiece WP, or a multi-level image having a gray value in accordance with a height of the workpiece WP. Further, it may also be a multi-level image obtained by converting a distance from the imaging unit 202 to a gray value for each pixel of the luminance image.

Processing of the shape inspecting device 1 of the embodiment includes: (1) a distance image acquiring step of acquiring, by the controller part, a distance image that includes height information in a surface shape of the workpiece WP; (2) a display step of displaying the acquired distance image on the display part 6; (3) a window setting step of setting a window for defining a measurement area on the distance image displayed on the display part 6; (4) a segment setting step of setting a plurality of segments arrayed in one direction in the measurement area defined by the window; (5) a representative value selecting step of selecting a type of a representative value concerning height information in each pixel included in each segment of the plurality of segments; and (6) a representative value extracting step of obtaining the representative value selected in the representative value selecting step for each segment. As a modified example, the window setting step ((3) above) may be omitted.

Since the above method for defining a measurement area by a window prior to setting of segments is described in JP 2004-145505 A and JP 2009-186338 A, a detailed description thereof is omitted by citing JP 2004-145505 A and JP 2009-186338 A to the present specification.

By setting a window, the measurement area can be narrowed down, and further by setting a plurality of segments arrayed in one direction in this window to determine a defect of the surface shape based on a representative value on the basis of height information of a plurality of pixels included in each of the segments, a processing speed can be increased. Further, from the representative values of the plurality of segments arrayed in one direction, when this one direction is referred to as a trend direction, it is possible to grasp a trend of the surface shape of the workpiece along the trend direction, namely, a tendency of the whole shape of the workpiece surface, i.e., the workpiece surface being a circular arc, a straight line or a free curve in the trend direction. This trend direction can be also referred to as an extending direction of a window 20 or an arraying direction of the segments 30.

Automatic Setting of Segments 30:

FIG. 2 shows a case where a rectangular window 20 extending in a horizontal direction is set. In this window 20, a plurality of segments 30 are set in its longitudinal direction, namely, the horizontal direction. The user may designate or set a width W of each segment 30 and a distance (pitch) Pt between two adjacent segments 30. Designation of the segment width W and the pitch Pt is equivalent to designation of the number of pixels.

Based on the segment width W and the pitch Pt designated or set by the user, a plurality of segments 30 are sequentially allocated at equal intervals from the left end to the right end of the window 20. As a modified example, the user may designate or set the segment width W and the number of segments 30. In this case, the segments 30 in the number designated or set by the user and having the same segment width W may be automatically arrayed at equal intervals in the window 20.

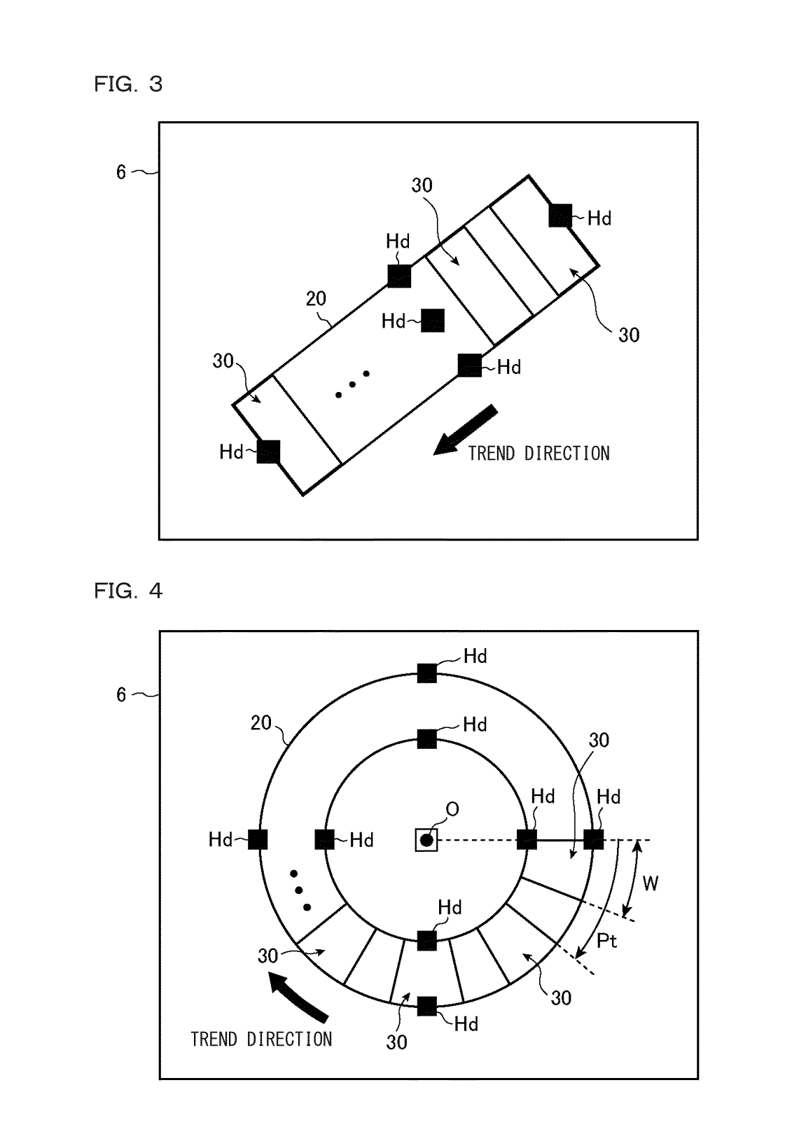

FIG. 3 shows a case where the window 20 is diagonally set. In the example of FIG. 3, in this window 20, a plurality of segments 30 are sequentially allocated from the upper side to the lower side of the window 20.

FIG. 4 shows an example where the window 20 is set in the shape of a circular ring. In this case, the segment 30 is set clockwise with a three-o'clock line as a start point. In this case, the width W of the segment 30 and the pitch Pt between the segments 30 correspond to an angle from a line passing through a center O of the ring-shaped window 20, which is the three-o'clock line in this embodiment.

Although FIG. 4 illustrates an example where an outer peripheral circle and an inner peripheral circle of the circular ring-shaped window 20 are concentric, this illustrative example is merely a typical example, and a center of the outer peripheral circle and a center of the inner peripheral circle may be different.

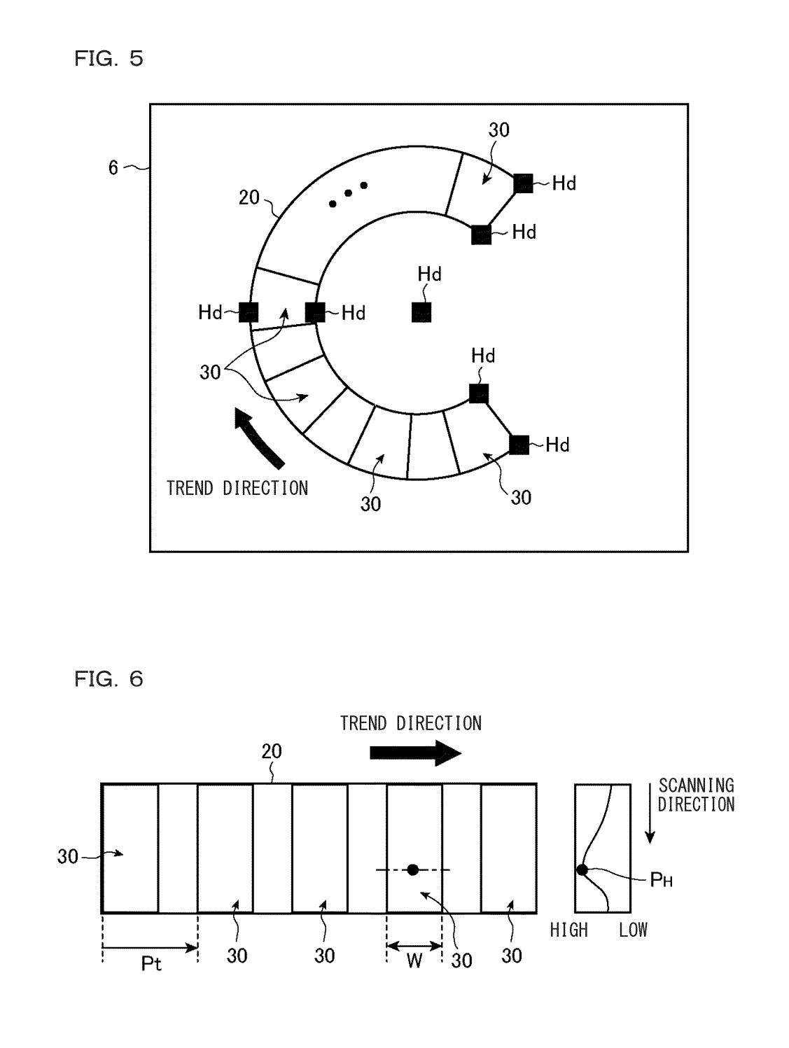

FIG. 5 shows an example where the window 20, having a C shape formed by cutting off part of a circular ring, is set. Also in this case, the segments 30 are set clockwise. With the delay side end in a clockwise direction as a start point, the segments 30 are set clockwise from this start angle.

Although FIG. 5 illustrates an example where an outer arc and an inner arc of the C-shaped window 20 are concentric, this illustrative example is merely a typical example, and a center of the outer arc and a center of the inner arc may be different.

When the window 20 in the circular ring shape or in the shape formed by cutting off part thereof is set, a circumferential or arc-shaped area may be subjected to polar-coordinate conversion inside the controller part 4, to be processed in the state of being converted into a rectangular shape.

In defining a size and an angle of inclination of the window 20 having the rectangular shape, the circular ring shape or the C shape formed by cutting off part thereof, a handle Hd (FIGS. 2 to 5) may be displayed on the display part 6, and the user may operate this handle Hd to allow setting of the window 20 with a desired size, a desired radius and a desired angle of inclination. The trend direction is defined by the extending direction of this window 20. Then, a plurality of segments 30 with the segment width W and the pitches Pt designated by the user are arrayed in the trend direction in the measurement area marked out by the window 20.

Although the examples of automatically setting the segment 30 in the window 20 have been described above, as a modified example of automatic setting of the segments 30, the step of setting the window 20 may be omitted. Describing this modified example, first, the user designates on the display part 6 a start position and an end position for setting the segments 30. Then, a plurality of segments 30 are automatically set between the start position and the end position in accordance with the segment width W and the pitch Pt designated by the user. The segment width W and the pitch Pt are equivalent to the number of pixels. It is preferred that the user designates whether the plurality of segments 30 are arrayed on a straight line or arrayed on a circumference. In the case of arraying the segments 30 on a circumference, the user may designate three points that can specify this circumference, for example.

Calculation of Height in Segment 30:

A representative value suitable for detecting a shape defect of the workpiece WP can be designated by the user. For example, types of representative values may be menu-displayed on the display part 6, and the user may be able to select a desired representative value among them. In the shape inspecting device 1 of the embodiment, there can be selected one out of three types of representative values: (1) average height; (2) maximum height; and (3) minimum height.

(1) Average Height:

When the user designates an “average height” as a representative value, an average value of height information of all pixels included in each segment 30 is calculated, and this average value becomes the representative value of each segment 30. Each representative value obtained as a result of the computing has position information of each segment. By selecting a representative value having this characteristic, it is possible to specify in which segment a defect position exists.

(2) Maximum Height:

There are two methods for obtaining a maximum height. A first method for obtaining the maximum height is extracting the maximum height from height information of all the pixels included in each segment 30. According to this representative value obtained as a result of the selection, it is possible to specify the maximum height of each segment 30 and also a pixel having the maximum height information. Since each pixel itself has position information, it is possible to specify which pixel has the maximum height information. That is, there is an advantage of being able to specify which position has the maximum height in each segment 30. Each pixel substantially has position information in addition to the height information. By adopting a representative value with this characteristic, it becomes easy to specify a defect position.

A second method for obtaining the maximum height is acquiring the maximum height by averaging processing. This second method will be described with reference to FIG. 6. FIG. 6 is a diagram for conceptually explaining the method for obtaining the maximum height by averaging processing. The second method includes two steps.

In a first step, all the pixels included in each segment 30 are subjected to averaging processing (projection processing) for heights of each row of pixel groups arrayed in the trend direction, sequentially from the top of the pixel groups, to acquire one-dimensional data concerning the height. The one-dimensional data concerning the height of each pixel row is shown on the right of FIG. 6.

In a second step, a one-dimensional data group of each pixel row is scanned in a direction vertical to the trend direction. The one-dimensional data PH (FIG. 6) of the maximum height is acquired by this second step. This one-dimensional data PH of the maximum height becomes a representative value. This representative value has information on which row the maximum height exists. By selecting a representative value having this characteristic, it is possible to specify on which row of which segment the defect position exists.

Performing the above averaging processing (projection processing) allows acquisition of a representative value not susceptible to significant noise. Naturally, it is possible to adjust the degree of the averaging by changing the width W of the segment 30.

As for the method for obtaining the maximum value, the first method or the second method may be selected by the user, or only the first method or the second method may be adopted.

(3) Minimum Height:

Similarly to the above maximum height, there are two methods for obtaining a minimum height. A first method for obtaining the minimum height is extracting the minimum height from height information of all the pixels included in each segment 30. According to this, it is possible to specify the minimum height of each segment 30 and also a pixel having the minimum height information.

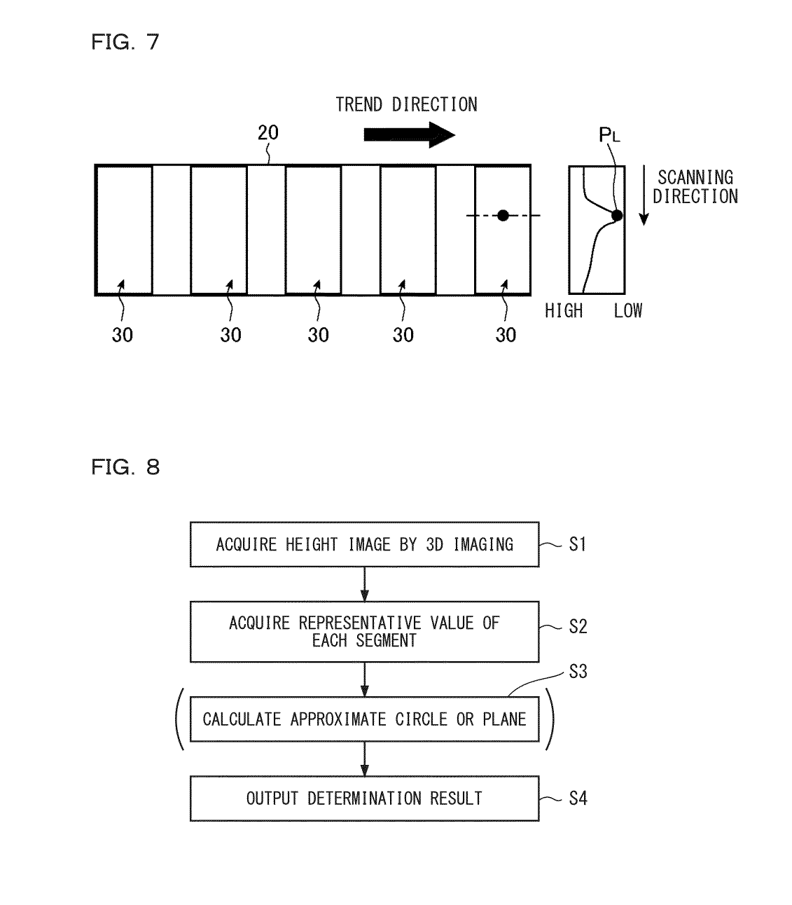

A second method for obtaining the minimum height is acquiring the minimum height by averaging processing. This second method will be described with reference to FIG. 7.

In a first step, all the pixels included in each segment 30 are subjected to averaging processing (projection processing) for heights of each row of pixel groups arrayed in the trend direction, sequentially from the top of the pixel groups, to acquire one-dimensional data concerning the height. The one-dimensional data concerning the height of each pixel row is shown on the right of FIG. 7.

In a second step, a one-dimensional data group of each pixel row is scanned in a direction vertical to the trend direction. One-dimensional data PL (FIG. 7) of the minimum height is acquired by this second step. This one-dimensional data PL of the minimum height becomes a representative value. This representative value has information of a pixel row having the minimum height. As for the method for obtaining the minimum value, the first method or the second method may be selected by the user, or only the first method or the second method may be adopted.

As described above, the segment 30 is automatically set by the internal processing of the controller part 4. As for the segment width W and the pitch Pt set by the user, a value larger than the segment width W is generally set as the pitch Pt, but the pitch Pt may be set to a value smaller than the segment width W. When the pitch Pt is set to a value smaller than the segment width W, the two mutually adjacent segments 30 overlap with each other. By an averaging effect due to this overlapping, it is possible to carry out stable measurement and detection susceptible to noise at closer intervals.

By setting the segment width W to a large value, it is possible to acquire a schematic tendency of the surface shape (trend direction) of the workpiece WP. In other words, it is possible to acquire only a tendency such as large distortion without being influenced by fine unevenness of the surface. On the other hand, when the segment width W is set to a small value, it is possible to acquire a detailed tendency of the surface shape (trend direction) of the workpiece WP. In other words, it is possible to acquire a tendency following the fine unevenness of the surface.

When a large value is set as a value of the pitch Pt in the relative relation with the segment width W, it is possible to obtain a rough trend as a whole. On the other hand, when a small value is set as a value of the pitch Pt in the relative relation with the segment width W (e.g., the adjacent segments 30 are made to overlap with each other), it is possible to obtain a detailed surface shape of the workpiece WP in the trend direction.

The shape inspecting device 1 of the embodiment has two modes concerning a method for determining a shape defect. A first mode is to prepare a common tolerance with respect to all the segments 30, and make a “defective” determination when a representative value of any one segment 30 exceeds the tolerance.

A second mode is to obtain a reference model line, and make a “defective” determination when a difference between this reference model line and a representative value of each segment 30 exceeds a threshold.

First Mode (FIGS. 8 to 20):

The first mode is to make the defect determination based on whether or not the representative value of each segment 30 is within the range of the common tolerance.

Zero Plane:

A plane (background) where each segment 30 should originally be may be set as a “zero plane”, and a value of the above representative value may be adjusted with respect to this zero plane. This is a concept that, for example, when an image of the workpiece WP is captured in an inclined state, it is the zero plane which corrects the inclination. By performing this zero plane correction, it is possible to obtain a surface height of the workpiece WP with the zero plane taken as a reference.

A zero plane common to all the segments 30 may be set, or zero planes each different for each segment 30 may be set. For example, when the workpiece WP has a warp, it is effective to set a different zero plane for each segment 30.

FIG. 8 is a flowchart for explaining a processing procedure for the first mode. With reference to FIG. 8, first, a distance image (height image) is acquired (S1). It may be an image acquired by any method as long as it is an image outputted in the form of a height image, the method being three-dimensional measurement by the light sectioning method that assumes the moving workpiece WP, or the like, other than the three-dimensional measurement by the phase shifting method or the space coding method that assumes the still state as described above.

In next Step S2, a representative value of each segment 30 is acquired. The representative value of each segment 30 may be a representative value adjusted by the zero plane common to all the segments 30, or may be a representative value adjusted by the zero plane set for each individual segment 30. Selection of this may be left to the user.

Next Step S3 is an arbitrary step, and if it is unnecessary, the processing moves to next Step S4. In other words, Step S3 is executed by the user's setting. An approximate circle or a plane, which expresses the trend of the surface of the workpiece WP based on the representative value of each segment 30, is obtained based on the following formula:

(1) Approximate Circle:

Using the array of the representative value (height data) of each segment 30 and the pitch Pt between the two adjacent segments, values may be applied to a circle formula by a least squares method based on the following formula:

(x−A)²+(z−B)²=R²

Here, x is a movement amount of each segment 30, namely, a distance from the segment at a start position,

z is the representative value (height data) of each segment 30, and

A, B and R are coefficients of a circle formula to be obtained.

According to the above formula, by converting three-dimensional shape data into two dimensional data of an “x-direction: movement amount of the segment 30” and a “z-direction”, it is possible to obtain an approximate circle based on a relatively simple calculation formula without performing complicated three-dimensional computing. Naturally, this has an advantage of increasing a processing speed.

(2) Plane:

From the array of the representative value (height data) of each segment 30, values may be applied to a plane formula by a least squares method based on the following formula:

A·x+B·y+C·z+1=0

Here, x, y and z are three-dimensional coordinate values of a point of the representative value, and

A, B and C are coefficients of a plane formula to be obtained.

In Step S4, when each representative value is outside the range of the tolerance, the “defective” determination is made, and when it is within the range of the tolerance, a “non-defective” determination is made. This determination result is then outputted. The “defective” determination may be made based on the number of representative values that are outside the range of the tolerance. As a modified example, the “defective” determination may be made when there are a plurality of successive representative values that are outside the range of the tolerance. Naturally, the “defective” determination may be made based on the number of successive representative values that are outside the range of the tolerance. In the case of the processing via Step S3, whether or not the calculated approximate circle or plane itself is in the range of the tolerance can be added to the determination result. For example, the “defective” determination may be made when a radius of the calculated approximate circle is outside the range of the tolerance or when a degree of inclination of the calculated plane is outside the range of the tolerance.

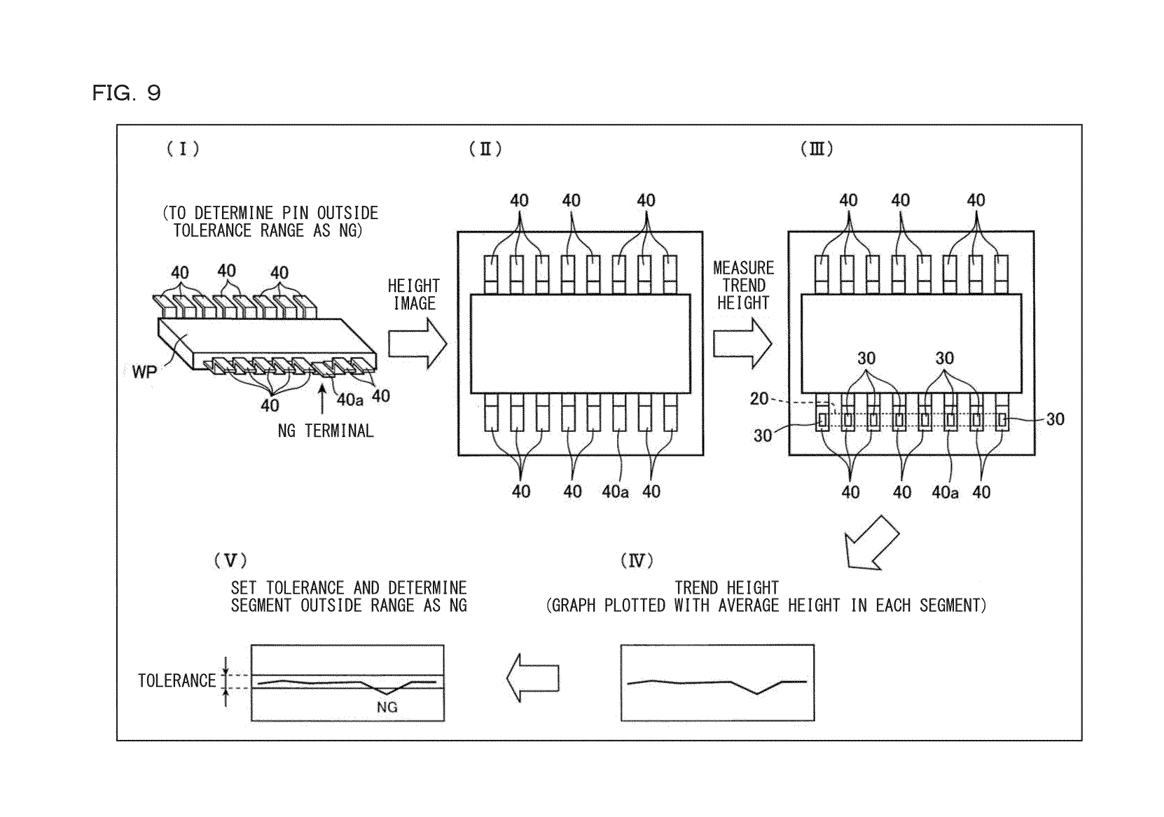

A specific example of the foregoing defect determination in the first mode will be described below. FIG. 9 shows an example of inspection of an electronic component WP provided with a plurality of terminals 40 located at equal intervals. In a regular shape of this electronic component WP, the plurality of terminals 40 are at the same height position. In (I) of FIG. 9, a height position of one terminal 40a is lower than a regular height position. A height abnormality in this terminal 40a should be detected and determined as NG. (II) of FIG. 9 shows a height image of the workpiece WP. (III) of FIG. 9 shows a state where the segment 30 is set on each terminal 40. (IV) of FIG. 9 is a graph plotted with an average height of each segment 30 at the time of the user designating an “average height” as a representative value. (V) of FIG. 9 shows a tolerance set by the user. An average height of the terminal 40a deviates from the range of the tolerance. Hence, an NG (“defective”) determination is made on this workpiece WP. Naturally, it is possible to specify which segment is defective.

With reference to FIG. 9, the plurality of terminals 40 are spaced from each other, and the surface of the workpiece WP does not exist between the two adjacent terminals 40. In such a case, as a method for displaying a representative value obtained from each segment 30 on the display part 6, an interval between the adjacent segments 30 is narrowed or eliminated, to display the representative value. That is, each representative value may be displayed in the form of ignoring an area where the terminal 40 does not exist or in the state of making the existence of the area where the terminal 40 does not exist visually clear by a straight line, for example. Hence, it becomes easy to visually grasp the whole trend of the terminal 40. This is also applicable to a case where the user sets the mutually adjacent segments 30 to be spaced from each other.

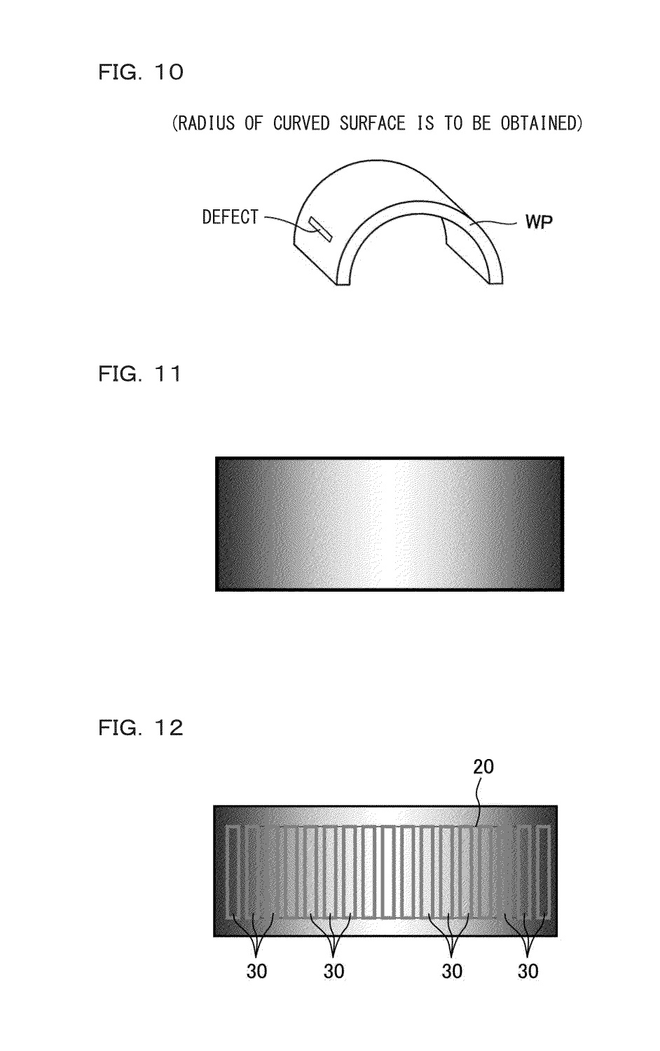

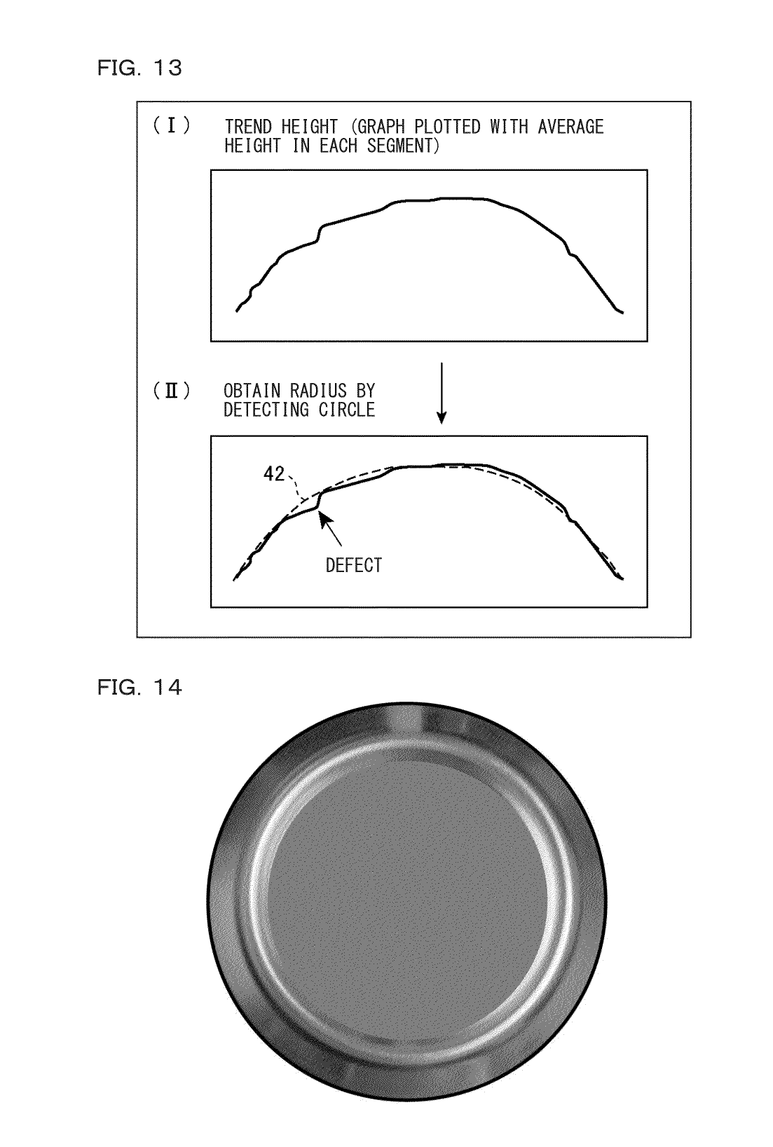

It is possible to obtain a radius of a semicircular workpiece WP by use of a function of the first mode. A specific example will be described with reference to FIGS. 10 to 13. FIG. 10 shows a workpiece WP with an arc-shaped section. When a radius of the outer surface of this workpiece WP is to be obtained, a captured image (height image) of the workpiece WP is fetched (FIG. 11). FIG. 12 shows a state where the segments 30 are set in the workpiece WP. (I) of FIG. 13 is a graph plotted with an “average height” of each segment 30. As can be seen from this graph, it is possible to see a trend of the surface shape of the workpiece WP. Then, a broken line in (II) of FIG. 13 shows an approximate circle 42 obtained by the above calculation formula based on this “average height”. The radius of the workpiece WP can be obtained from this approximate circle.

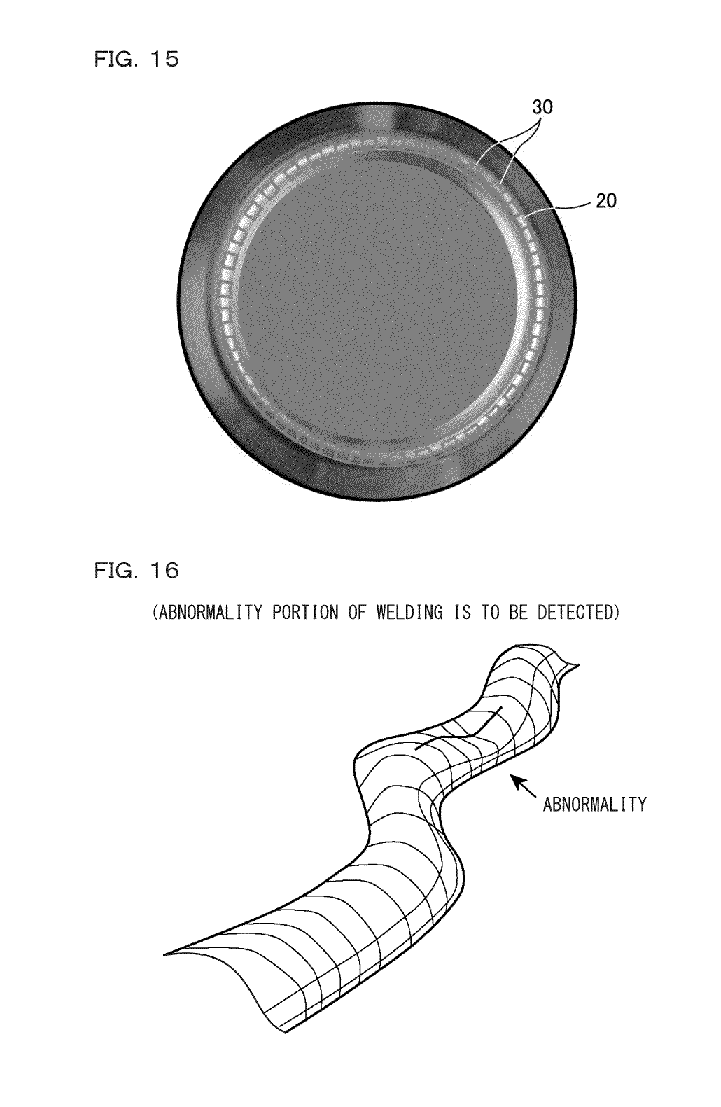

FIGS. 14 and 15 show examples of obtaining a volume of a recess on the bottom of a can. FIG. 14 shows the bottom of the can as the workpiece WP. FIG. 15 shows a captured image (height image) of the workpiece (can) WP. In the image of the bottom of the can shown in FIG. 15, circular arc frames are seen in the circular ring-shaped recess in a plan view on the bottom of the can, and these frames are the foregoing segments 30.

From data of a “maximum height” as a representative value of each segment 30, a plane is calculated based on the above calculation formula. The obtained plane is taken as a zero plane, and based on this zero plane, pixel values (distances from the zero plane) in the ring shape are integrated, to allow calculation of a volume of the recess.

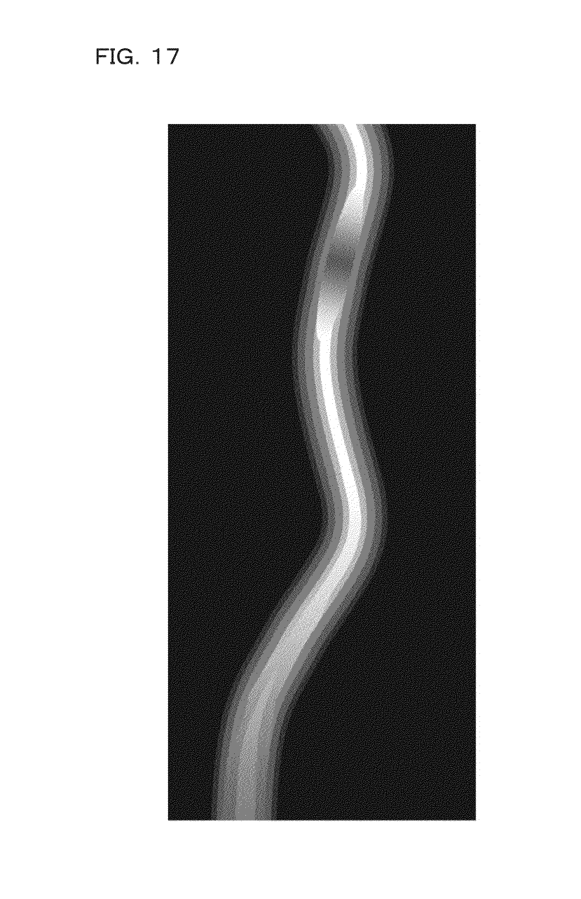

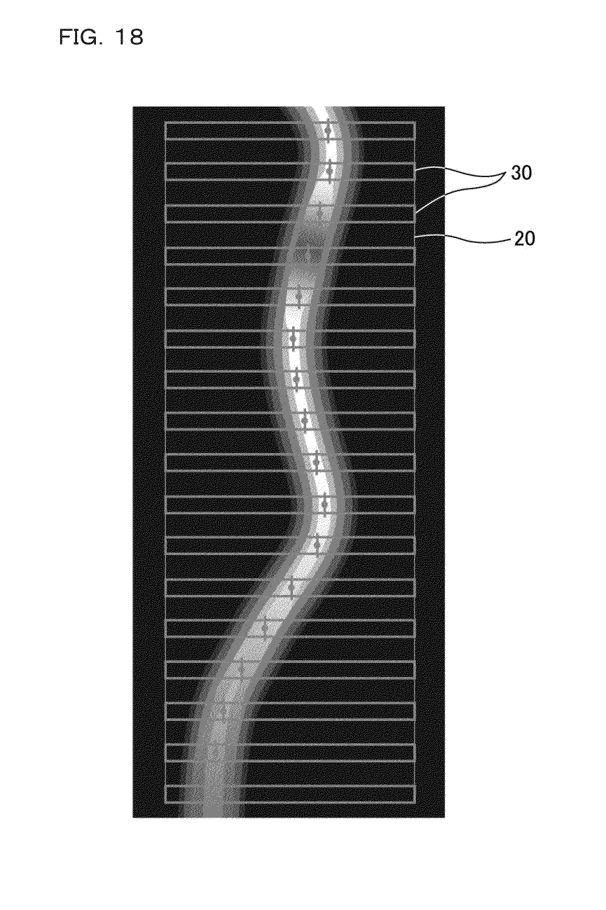

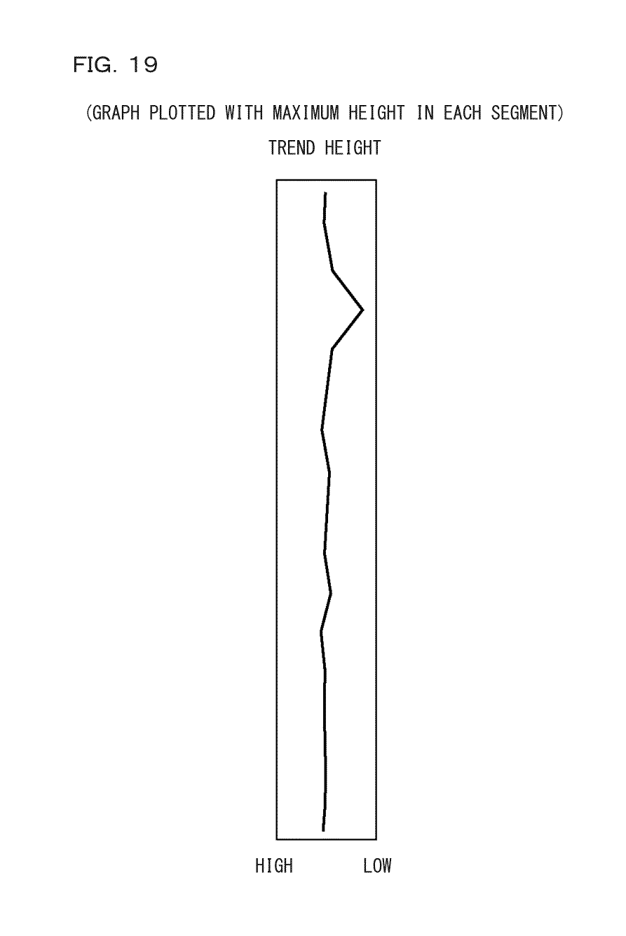

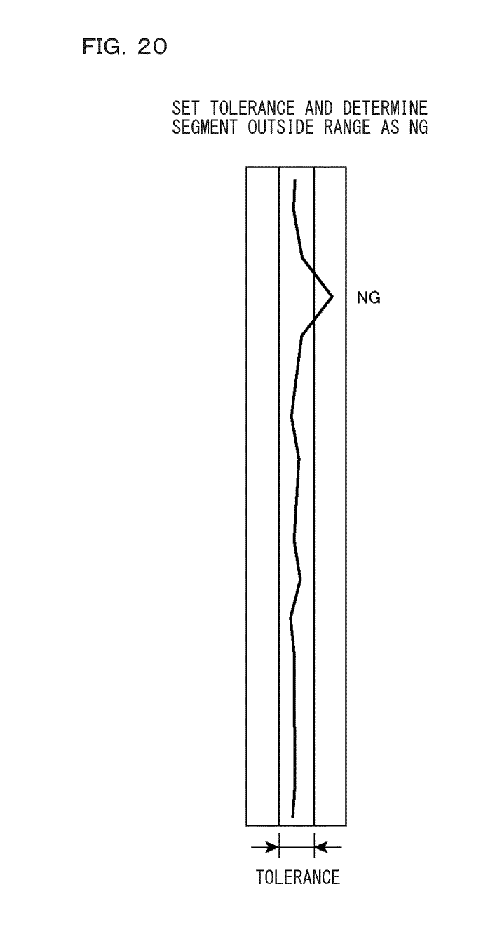

FIG. 16 shows a welded region. With reference to FIGS. 17 to 20, a description will be given of an example of detecting that this welded region has an abnormality. FIG. 17 shows a captured image (height image) of the welded region, and FIG. 18 shows a state where the segments 30 are set on the captured image of the welded region. A longitudinal rectangular frame of FIG. 18 is the segment 30. FIG. 19 shows a graph plotted with a maximum height of each segment 30. FIG. 20 shows a tolerance set by the user. Further, as can be seen from FIG. 20, the maximum height of part of the segments 30 deviates from the range of the tolerance in the welded region. Hence, an NG (“defective”) determination is made on this welded region. Naturally, a place deviating from the tolerance can be specified.

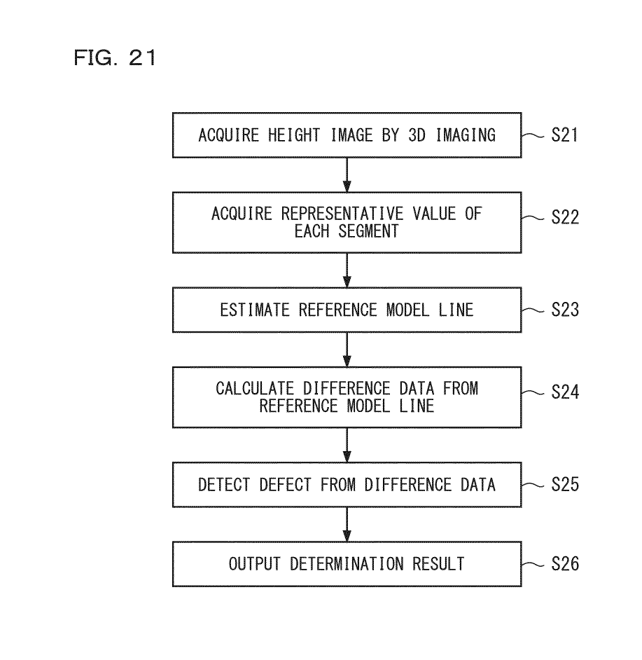

Second Mode (FIGS. 21 to 25):

The second mode is to estimate a reference model line of a trend based on the representative value of each segment 30, and make a defect determination based on whether a difference between the reference model line and the representative value of each segment 30 is larger or smaller than a predetermined threshold. In this second mode, the window 20 and the segment 30 are used as in the first mode. The window 20 and the segment 30 are the same as those in the first mode, and descriptions thereof are thus omitted.

FIG. 21 is a flowchart for explaining a processing procedure for the second mode. With reference to FIG. 21, acquisition of a distance image (height image) (S21) is the same as in the first mode (S1 of FIG. 8). In next Step S22, a representative value of each segment 30 is acquired. In next Step S23, a reference model line is estimated.

When the surface shape of the workpiece WP in the trend direction is a prescribed shape such as a straight line or a circle, the user may select the shape.

Reference Model Line of Straight Line:

A reference model line of a straight line may be obtained by the same method as that for the “plane” described in the first mode.

Reference Model Line of Circle:

A reference model line of a circle may be obtained by the same method as that for the “approximate circle” described in the first mode.

Reference Model Line of Free Curve:

When the surface shape of workpiece WP can be applied to a prescribed formula, similarly to the straight line and the circle described above, a polynomial with two variables using x and z may be prescribed, and based on this formula, the least squares method is applied to obtain a free curve. Since a specific method for this is described in detail in JP 2009-186338 A, a detailed description thereof is omitted by citing JP 2009-186338 A to the present specification.

It is to be noted that, when the surface shape of the workpiece WP cannot be expressed by a prescribed formula, data obtained by leveling the representative value (height data) of each segment 30 may be generated, and based on a difference between the leveled data and original data, a place with a height different from those of its periphery (trend) may be detected.

Returning to the flowchart of FIG. 21, in next Step S24, when the reference model line is taken as a reference, a differential value (difference data) of the representative value of each segment 30 is obtained. That is, when the reference model line is rephrased as trend height data, a difference between this trend height data and each representative value is calculated.

In next Step S25, each difference data and a threshold previously set by the user are compared, and a portion of difference data exceeding the threshold is detected as defective. The defect determination may be made when the number of defect regions, namely, the number of difference data exceeding the threshold, is larger than a predetermined number. Further, the defect determination may be made when the number of successive defect regions, namely, the number of successive difference data exceeding the threshold, is larger than a predetermined number.

In next Step S26, the “defective” determination or “non-defective” determination is made based on the defect information detected in Step S25 above, and the determination result is outputted.

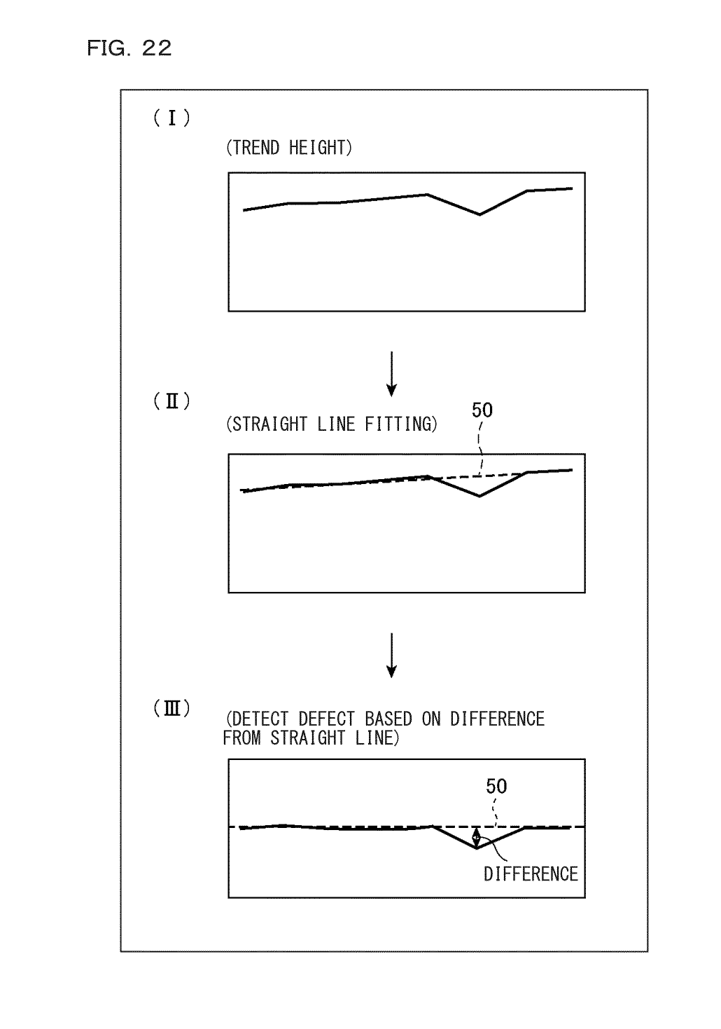

A specific example of the defect determination in the second mode will be described below. (I) of FIG. 22 corresponds to (IV) of FIG. 9. That is, (I) of FIG. 22 is a graph obtained by setting the segment 30 on each terminal 40 of the captured image of the workpiece WP in (I) of FIG. 9, namely, the electronic component, and plotting a representative value of each segment 30 in the case of designating an average height as the representative value of each segment 30.

(II) of FIG. 22 is a graph obtained by estimating a reference model line of the straight line in Step S23 of FIG. 21 and generating a reference model line based on the above representative values. A broken line in (II) of FIG. 22 is a reference model line 50. (III) of FIG. 22 is a diagram for explaining that difference data between the reference model line 50 and each representative value is obtained (cf. Step S24 of FIG. 21). Then, defect detection is performed based on whether or not this difference data exceeds a predetermined threshold.

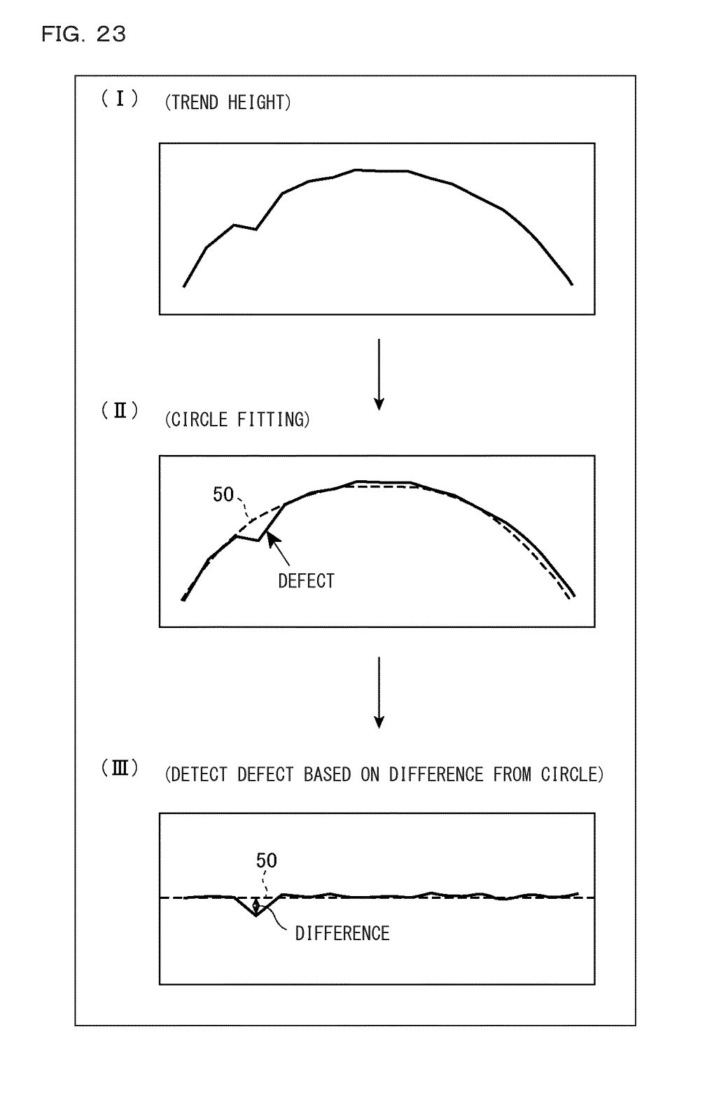

(I) of FIG. 23 corresponds to (I) of FIG. 13. That is, (I) of FIG. 23 is a graph obtained by setting the segment 30 in the captured image (height image) of the workpiece WP with an arc-shaped section shown in FIG. 10 (FIG. 12), and plotting an “average height” as a representative value of each segment 30. Next, a reference model line of a circle is estimated, and a broken line in (II) of FIG. 23 is a reference model line 50 generated based on the above representative values. (III) of FIG. 23 is a diagram for explaining that difference data between the arc reference model line 50 and each representative value is obtained. Then, defect detection is performed based on whether or not this difference data exceeds a predetermined threshold.

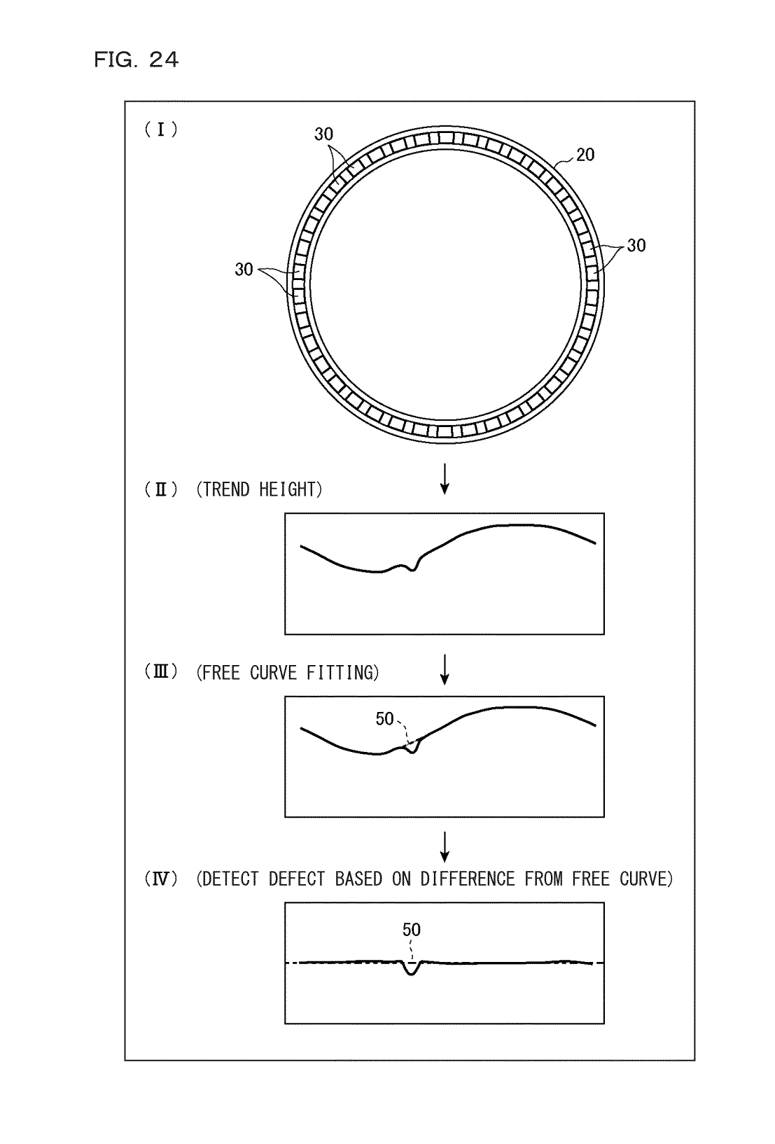

(I) of FIG. 24 is a diagram for explaining a state where the window 20 is set in the circular ring-shaped recess on the bottom of the can of FIG. 15, and the segments 30 are arrayed in this window 20. (II) of FIG. 24 is a graph obtained by plotting an “average height” as the representative value of each segment 30. When the surface shape of the recess on the bottom of the can in the trend direction is a free curve, a broken line in (III) of FIG. 24 is a reference model line 50 generated based on the representative value (average height) of each segment 30. (Iv) of FIG. 24 is a diagram for explaining that difference data between the arc reference model line 50 and each representative value is obtained. Then, defect detection is performed based on whether or not this difference data exceeds a predetermined threshold. It can be seen from (Iv) of FIG. 24 that only a local change different from the trend (whole tendency) can be detected as defective.

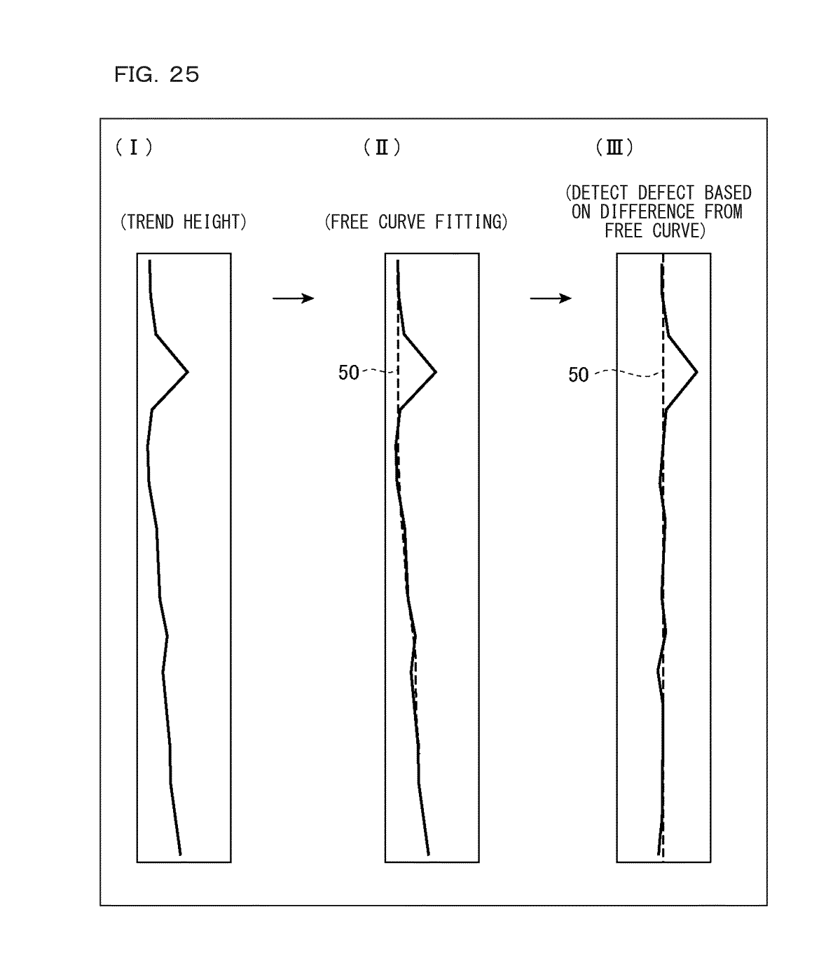

(I) of FIG. 25 corresponds to FIG. 19. That is, it is a graph plotted with a maximum height as a representative value of each segment 30 set in the captured image (height image) of the welded region (FIG. 16). (II) of FIG. 25 is a free-curve reference model line 50 (broken line) generated based on the representative value (maximum height) of each segment 30. (III) of FIG. 25 is a diagram for explaining that difference data between this free-curve reference model line 50 and each representative value is obtained. Then, defect detection is performed based on whether or not this difference data exceeds a predetermined threshold.

Even when the shape is irregular and meandering as that of the welded region (FIG. 16), it is possible to acquire data for estimating a reference model line 50 by following a position of the maximum height of each segment 30. Then, defect detection is performed based on difference data obtained by comparison between the maximum height of each segment 30 and the free-curve reference model line 50, and hence it is possible to detect only a defect region that abruptly changes while substantially ignoring a gentle increase and decrease in difference in the relation with its periphery.

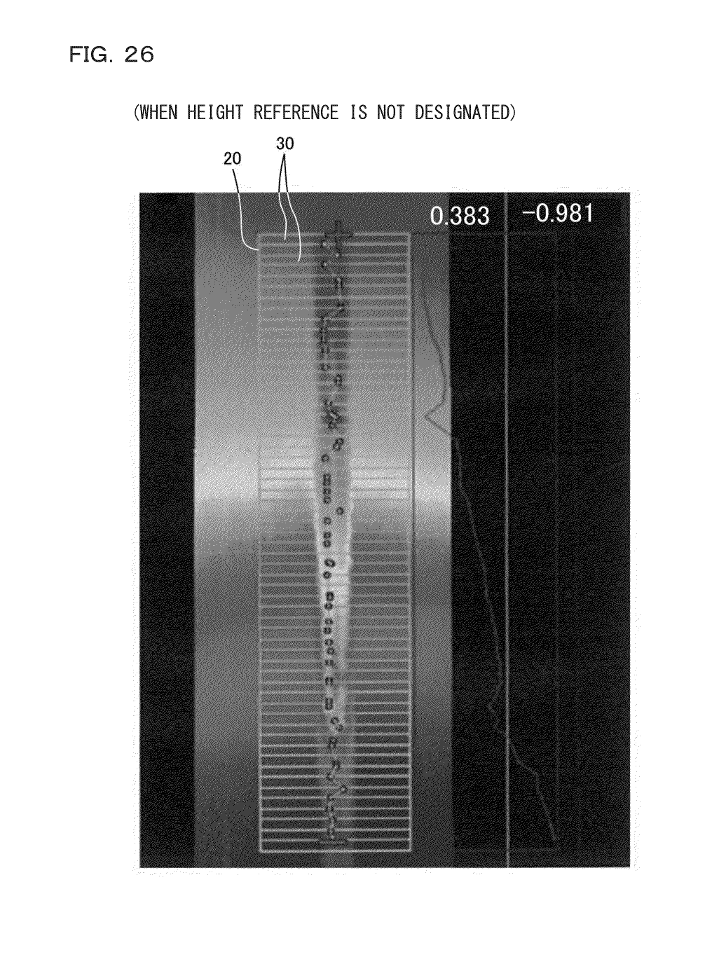

About Setting of Zero Plane (FIGS. 26 to 30):

Describing by use of the foregoing specific application examples, when the welded region illustrated in FIG. 16 is a measurement target, there is no problem if a metal plate to be a base of this welded region is a complete plane, but the metal plate may be in various states such as waved, warped or rounded. In such a case, the height of the measurement target is influenced by warping and the like of the metal plate to be the base. In other words, when the height of the measurement target is influenced by the shape of the surface related to the measurement target, this influence needs to be eliminated.

In order to remove disturbances such as inclination, warping, roundness and waviness of the surface which influence the height of the measurement target, it is possible to set a zero plane in accordance with the height of the measurement target. The zero plane includes “plane reference”, “average height reference” and “real-time thee point designation”, for example. The user may designate any one of these three. When the user designates any of the “plane reference”, “average height reference” and “real-time thee point designation”, or selects a “mode based on a height standard”, the shape inspecting device 1 enters a measurement mode based on a “height reference”.

Further, in order to acquire height information of the plane which influences the height of the measurement target, a second measurement area for acquiring information required for obtaining the zero plane is set differently from the foregoing segments 30. This second measurement area may be set by the user making an area designation on a captured image displayed on the display part 6.

The plurality of segments 30 are each set in a portion whose height is to be measured in the displayed image on the display part 6. The second measurement area may be typically set on the side of the measurement target, for example, on the side of the segment 30. This second measurement area may successively extend in the arraying direction of the plurality of segments 30, or may be set in each segment 30.

Plane Reference:

A least squares plane calculated by using three-dimensional information of height image (plurality of pixels) in the second measurement area is taken as the zero plane.

Average Height Reference:

A plane, whose Z-section is an average value of Z-values of the height image in the second measurement area and which is parallel to a reference plane of an imaging system, is taken as the zero plane.

Real-Time Thee Point Designation:

A height of a plane calculated by using three-dimensional information of three pixels designated by the user is taken as a reference. Naturally, the user may designate a plurality of points of more than three, and a plane may be obtained by three-dimensional information of pixels of these points. In this case, a least squares plane is calculated from the plurality of points and taken as the zero plane.

FIG. 26 is a height image of the welded region (FIG. 16) at the time when the height reference is not designated by the user and the reference plane of the imaging system is taken as the zero plane. FIG. 26 is actually a color image. A background around the welded portion is red, orange, yellow, yellow green, green, blue green, blue and indigo in this order from the top to the bottom. These colors show differences in height. A vertically extending graph seen on the right of the captured image (welded portion) shows a height of each place of the welded portion. The left is “high” and the right is “low”. That is, the captured image is higher toward its top and lower toward its bottom.

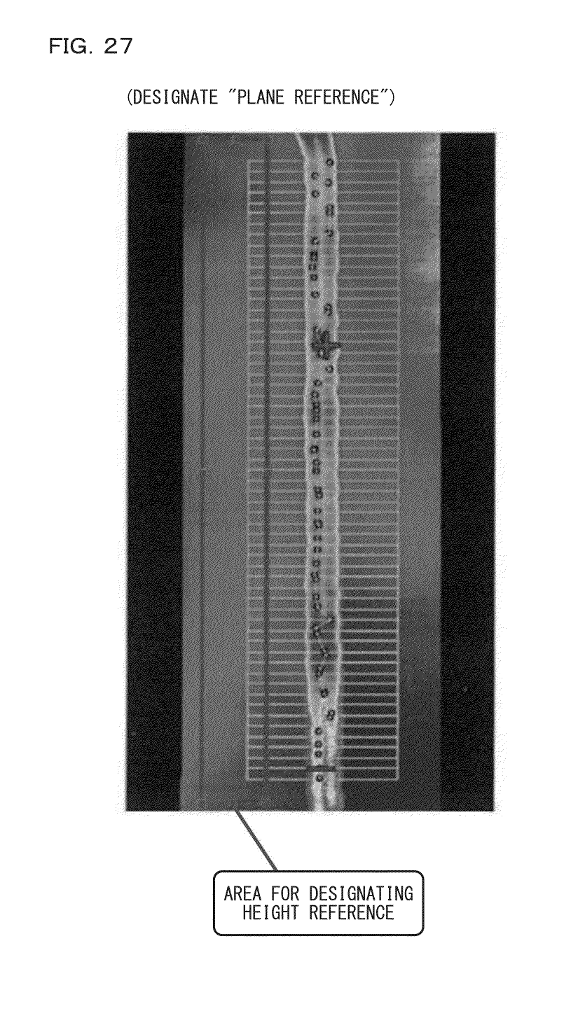

FIG. 27 is a height image of the welded region (FIG. 16) at the time when the user designates the “plane reference”. Vertically arrayed longitudinal frames are the segments 30. It can be seen that a large number of segments 30 are set as vertically arrayed. A vertically (arraying direction of the segments 30) extending frame is seen on the left end of the height image. This frame is the foregoing second measurement area. A least squares plane calculated by using three-dimensional information of the height image (plurality of pixels) in this vertically extending second measurement area is the “plane reference”. The height information of each segment 30 is corrected by this plane reference. FIG. 27 is actually a color image. As a whole, the background around the welded portion is blue and green, and regions that are red, yellow, orange and the like are seen in the welded portion.

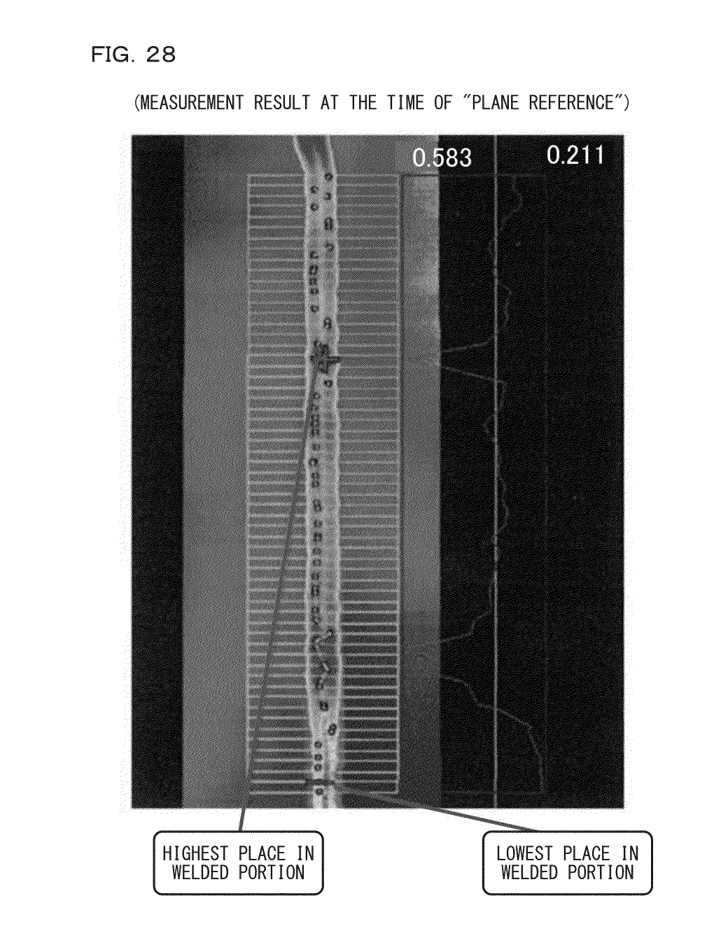

FIG. 28 shows a measurement result at the time when the “plane reference” is designated. A vertically extending graph seen on the right of the captured image (welded portion) shows a height of each place of the welded portion. It can be seen that a lower portion of the welded portion is clearly shown.

In the measurement based on each of the “height reference” with reference to FIGS. 27 and 28, the second measurement area greatly extending in the arraying direction of the segments 30 has been set. Accordingly, even when the reference plane (iron plate including the welded region in the present embodiment) on which the inspection target is placed is diagonally inclined, it is possible to cancel its influence and correctly measure height information of the inspection target region in the segment 30.

In the present embodiment, since the “plane reference” is selected from the second measurement area, when waviness or roundness exists on the reference plane of the inspection target, the actual reference plane of the inspection target cannot be approximated by the zero plane made of a plane, which may prevent correct measurement. Therefore, a slight difference in color showing a difference in height exists in the background portion showing the reference plane of FIG. 28.

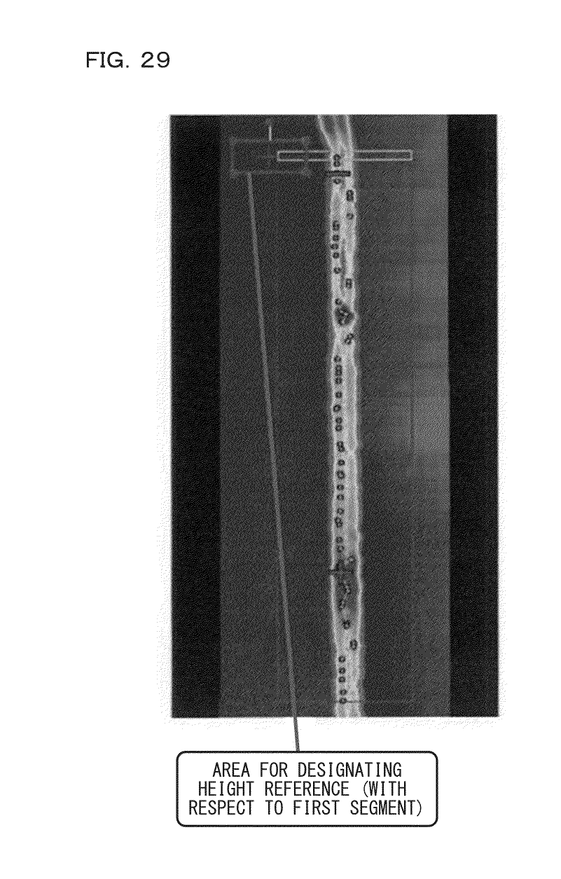

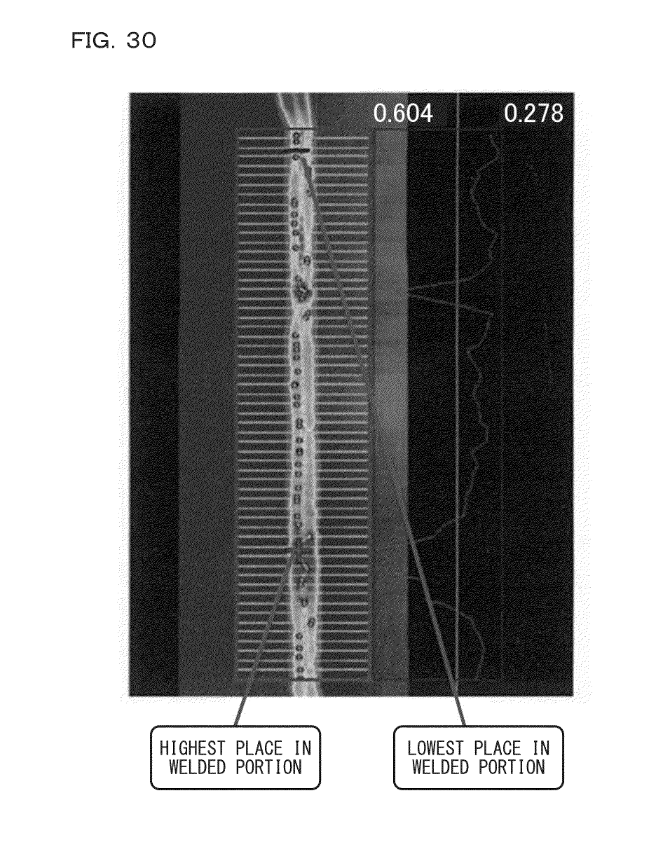

FIGS. 29 and 30 show an example of setting the second measurement area in each segment 30. FIGS. 29 and 30 show a height image of the above welded region (FIG. 16). A longitudinal rectangular frame seen in the upper part of FIG. 29 is the segment 30. A frame is seen on the left of this segment 30, and this frame located on the left side is the second measurement area. When a relatively small second measurement area is designated, mainly, the “plane reference” or the “average height reference” is selected. FIGS. 29 and 30 show an example at the time when the “plane reference” is designated.

FIG. 30 shows a measurement result at the time when the “plane reference” is designated. A vertically extending graph seen on the right of the captured image (welded portion) shows a height of each place of the welded portion. It can be seen that a lower portion of the welded portion is clearly shown.

In the above embodiment, the zero plane to be applied to each segment is obtained from the least squares plane calculated by using the three-dimensional information in the small area corresponding to each segment. That is, the height information of each segment is calculated, with the least squares plane, obtained from the small area provided in the vicinity of each segment, taken as the zero plane. This allows setting of the zero plane that follows the actual plane of the inspection target, and as compared to the embodiment of FIG. 28, even when waviness or roundness exists on the actual plane of the inspection target, it is possible to cancel an influence of these and correctly measure the height information.

Although the zero plane to be applied to each segment has been the “plane reference” in the present embodiment, it may be the “average height reference”.

A shape, a size and a position of the small area corresponding to each segment can also be set individually in each small area. Accordingly, even if it is difficult to linearly arrange the positions of the small areas, such as in a case where the position of the welded region to be inspected nonlinearly changes on the two-dimensional plane, each small area can be arranged in accordance with the actual position or shape of the welded region.

Further, it is possible to set the position of each small area by adjusting an offset amount with respect to a central position of each segment (a center of a direction orthogonal to the arraying direction of the segments). Since each small area is for setting the reference plane of the inspection target region, the user adjusts an offset amount in accordance with an actual width of the inspection target region such that the inspection target region is not included in the small area. It is to be noted that, by commonly setting the offset amount, the positions of all the small areas can be collectively set. Needless to say, the shape and the size of each small area can be collectively set.

As described above in the flowchart of FIG. 21 (Step S25), a defect determination may be made when the number of defect regions, namely, the number of segments 30 whose representative values exceed the threshold, is larger than a predetermined number (NG segment number). Accordingly, it is possible to output an abnormality when the number of segments exceeding the threshold is large as a whole, without outputting an abnormality due to abrupt noise. The number of NG segments can be set by the user.

Further, a defect determination may be made when the number of successive defect regions (segments 30 whose difference data exceeds a threshold), namely, the number of successive segments 30 whose representative values exceed a threshold, is larger than a predetermined number. For example, in a case where an abnormality in a built-up amount of the welded portion is to be detected, there may be a case where a portion whose built-up amount abruptly became large is not to be determined as an abnormality, but the built-up amount successively insufficient in a certain section is to be determined as an abnormality. In such a case, the number of times when the representative value (e.g., maximum value) of each segment successively falls below the threshold is counted, and when the count reaches a number equal to or larger than a certain number (the number of successive NG segments), an abnormality is outputted. The number of successive NG segments can be set by the user.

Although the embodiment of the present invention has been described above, this embodiment is merely an illustration of the specific example of the present invention. For example, although an “average value”, a “maximum value” and a “minimum value” have been illustratively cited as a representative value, a later-described inflection point may also be adopted as a representative value. A pixel originally has position (coordinate) information as its image information. When an inflection point, a maximum value or a minimum value is designated as a representative value, it is possible to specify a pixel having this inflection point, maximum value or minimum value. That is, it is possible to acquire position information of a pixel showing the inflection point, the maximum value or the minimum value.

On the other hand, a specific pixel cannot be specified by an average value. However, when an average value is designated as a representative value, it is possible to specify a segment 30 having a specific average value. It is then possible to specify a specific region of the workpiece WP by coordinates of the segment 30.

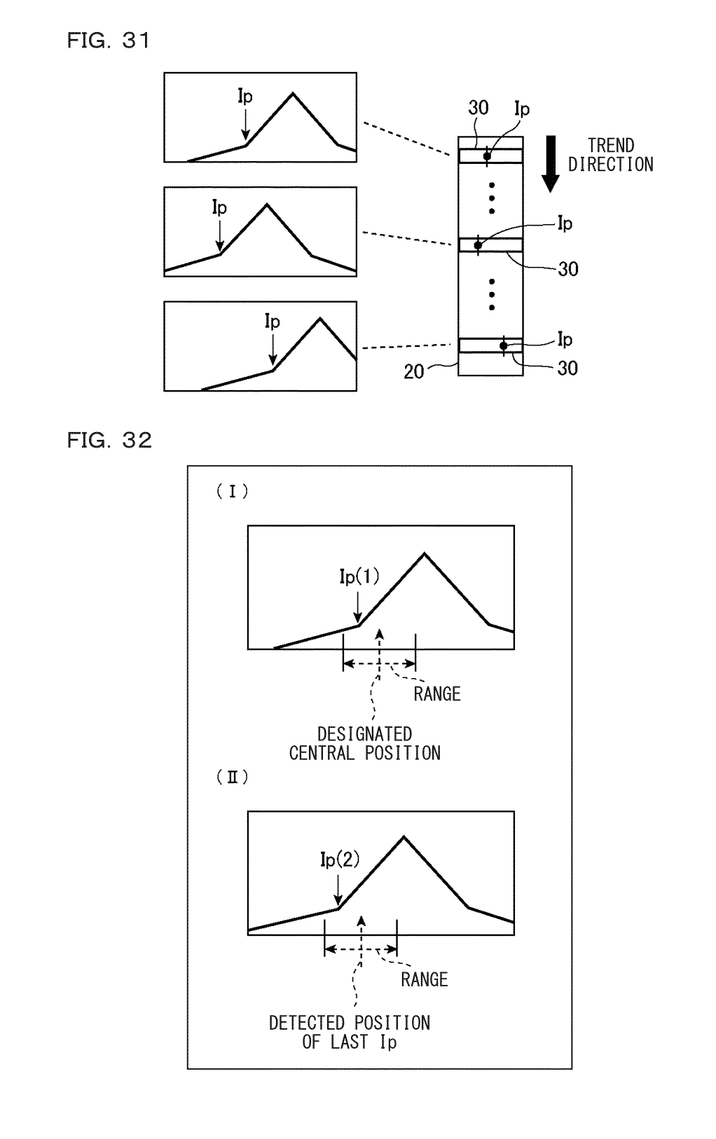

FIG. 31 is a diagram for explaining an example of measuring trend data of an inflection point, namely, a shape showing a tendency of an inflection point. That is, FIG. 31 is a diagram for explaining an example where when an inflection point Ip is included in a profile of the workpiece WP, namely, the surface shape thereof across the trend direction, trend data showing a tendency of this inflection point Ip in the trend direction is traced, to acquire this trend data. On the left of FIG. 31, the surface shape of each segment 30 across the trend direction is shown.

Inflection points include a ridge inflection point (convex upward) and a valley inflection point (convex downward). Further, even in the case where inflection points have the same bending degree, for example, in a ridge shape, a plurality of ridge inflection points may exist in the profile of the workpiece WP. These parameters can all be adopted as representative values. For example, a second ridge inflection point from the left can be adopted as a representative value.

FIG. 32 is a diagram for illustratively explaining one method in the case of measuring a desired inflection point. (I) of FIG. 32 shows a profile of the segment 30 at the start position, and (II) of FIG. 32 shows a profile of the second segment 30 therebelow.

In the first segment 30 displayed on the display part 6, a range or a center of the range as to which inflection point is to be acquired is designated ((I) of FIG. 32). In the next second segment 30, an inflection point Ip(2) in the range designated by the user in the previous first segment 30 is acquired with an inflection point Ip(1) of the first segment 30 taken as the center. Hereinafter, in the same manner, an inflection point Ip(n) of a range designated by the user is acquired with the inflection point Ip(n) of the last segment 30 taken as the center. By adopting this method, it is possible to acquire a desired inflection point in the profile of the workpiece WP without setting a parameter required for acquiring the desired inflection point.

What is claimed is:

1. A shape inspecting device comprising:
a distance image acquiring unit for acquiring a distance image that includes height information in a surface shape of a workpiece;
a display unit for displaying the acquired distance image;
a segment setting unit for setting a plurality of segments, arrayed in one direction, on the distance image displayed on the display unit; and
a representative value selecting unit for selecting a type of a representative value concerning height information in each pixel included in each segment of the plurality of segments,
wherein the representative value selected by the representative value selecting unit is obtained for each segment.

2. The shape inspecting device according to claim 1, further comprising
a window setting unit for setting a window, which defines a measurement area, on the distance image displayed on the display unit,
wherein the segments are allocated in the window set by the window setting unit.

3. The shape inspecting device according to claim 1, wherein the representative value is a value which is extracted from the height information in each pixel.

4. The shape inspecting device according to claim 3, wherein the representative value is a maximum height or a minimum height of a plurality of pixels included in each segment.

5. The shape inspecting device according to claim 1, wherein the representative value is a value obtained by computing based on the height information in each pixel included in the segment.

6. The shape inspecting device according to claim 5, wherein the representative value is an average value of the height information in each pixel included in the segment.

7. The shape inspecting device according to claim 5, wherein the representative value is a minimum height or a maximum height, obtained by acquiring one-dimensional data concerning a height by averaging processing on a pixel group arrayed in a trend direction with respect to all pixels included in each segment, and scanning a one-dimensional data group in a direction vertical to the trend direction.

8. The shape inspecting device according to claim 1 further comprising
a defect determining unit for making a defect determination based on whether or not each representative value exceeds a tolerance concerning a height of the surface shape of the workpiece in the one direction, in comparison with the tolerance.

9. The shape inspecting device according to claim 1, further comprising
a defect determining unit for obtaining a reference model line that serves as a reference of the surface shape of the workpiece in the one direction from the representative value of each segment, to make a defect determination based on whether or not a difference between the reference model line and each representative value exceeds a threshold.

10. The shape inspecting device according to claim 2, wherein a width of the segment and a distance between two adjacent segments, designated by the user, are accepted and the plurality of segments are allocated in the window based on the width of the segment and the distance between the two adjacent segments.

11. A shape inspecting method comprising:
a distance image acquiring step of acquiring a distance image that includes height information in a surface shape of an inspection target;
a display step of displaying the acquired distance image on a display part;
a segment setting step of setting a plurality of segments, arrayed in one direction, on the distance image displayed on the display part; and
a representative value selecting step of selecting a type of a representative value concerning height information in each pixel included in each segment of the plurality of segments,
the method comprising
a representative value extracting step of obtaining the representative value, selected by the representative value selecting step, for each segment.
